(19) United States
(12) Patent Application Publication
(10) Pub. No.: US 2014/0134016 A1
(43) Pub. Date: May 15, 2014

(54) USE OF PEEK FILM AS A WRAP INSULATION MATERIAL ON MAGNET WIRE

(71) Applicant: GE OIL & GAS ESP, INC., Oklahoma City, OK (US)

(72) Inventor: Edward John Flett, Oklahoma City, OK (US)

(73) Assignee: GE Oil & Gas Esp, Inc., Oklahoma City, OK (US)

(21) Appl. No.: 13/676,642

(22) Filed: Nov. 14, 2012

(51) Int. Cl. F04B 17/03; H02K 3/30; H02K 15/10

(52) U.S. Cl. CPC F04B 17/03; H02K 15/105; H02K 3/30
USPC 417/410.1; 29/596; 310/208

(57) ABSTRACT

An electrical submersible pumping system includes a pump assembly and a motor assembly. The motor assembly includes a plurality of stator coils and each of the plurality of stator coils comprises magnet wire. The magnet wire has an insulator surrounding a conductor and the insulator is manufactured from a polyether ether ketone film. In another aspect, the preferred embodiments provide a method for manufacturing a motor assembly for use in an electrical submersible pumping system. The method includes steps of preparing magnet wire having an electrical conductor and a polyether ether ketone film insulator.

### FIELD OF THE INVENTION

This invention relates generally to the field of electric motors, and more particularly, but not by way of limitation, to improved magnet wire for use in high-temperature downhole pumping applications.

### BACKGROUND

Electrodynamic systems such as electric motors, generators, and alternators typically include a stator and a rotor. The stator typically has a metallic core with electrically insulated wire winding through the metallic core to form the stator coil. When current is alternately passed through a series of coils, magnetic flux fields are formed, which cause the rotor to rotate in accordance with electromagnetic physics. To wind the stator coil, the wire is first threaded through the stator core in one direction, and then turned and threaded back through the stator in the opposite direction until the entire stator coil is wound. Each time the wire is turned to run back through the stator, an end turn is produced. A typical motor will have many such end turns upon completion.

Electrical submersible pumping systems include specialized electric motors that are used to power one or more high performance pump assemblies. The motor is typically an oil-filled, high capacity electric motor that can vary in length from a few feet to nearly fifty feet, and may be rated up to hundreds of horsepower. The electrical submersible pumping systems are often subjected to high-temperature, corrosive environments. Each component within the electrical submersible pump must be designed and manufactured to withstand these hostile conditions.

In the past, motor manufacturers have used various insulating materials on the magnet wire used to wind the stator. Commonly used insulation includes polyether ether ketone (PEEK) thermoplastics and polyimide films. Insulating the conductor in the magnet wire prevents the electrical circuit from shorting or otherwise prematurely failing. The insulating material is typically extruded or sprayed onto the underlying copper conductor. In recent years, manufacturers have used insulating materials that are resistant to heat, mechanical wear and chemical exposure.

Although widely accepted, current insulation materials may be inadequate for certain high-temperature downhole applications. In particular, motors employed in downhole applications where modern steam-assisted gravity drainage (SAGD) recovery methods are employed, the motor may be subjected to elevated temperatures. Extruded insulation material often suffers from variations in thickness, eccentricity and contamination as a result of the extrusion process. Prior film-based insulation requires the use of adhesive layers between the conductor and layers of film, which often has lower temperature performance than the film. There is, therefore, a need for an improved magnet wire that exhibits enhanced resistance to heat, corrosive chemicals, mechanical wear and other aggravating factors. It is to this and other deficiencies in the prior art that the present invention is directed.

### SUMMARY OF THE INVENTION

In preferred embodiments, the present invention includes an electrical submersible pumping system configured for operation in high-temperature applications. The electrical submersible pumping system includes a pump assembly and a motor assembly. The motor assembly includes a plurality of stator coils and each of the plurality of stator coils comprises magnet wire. The magnet wire has an insulator surrounding a conductor and the insulator is manufactured from a polyether ether ketone film.

In another aspect, the preferred embodiments provide a method for manufacturing a motor assembly for use in an electrical submersible pumping system, wherein the motor assembly includes a stator and a rotor. The method includes the steps of first providing an insulator film comprised of a polyether ether ketone polymer. The method calls secondly for the wrapping of the insulator film around an electrical conductor to form magnet wire. Next, the method continues by heating the magnet wire to the melting point of the insulator film to seal the film around the magnet wire. Lastly, the method includes the step of placing the magnet wire through the stator to produce motor windings.

### BRIEF DESCRIPTION OF THE DRAWINGS

FIG. 1 is a back view of a downhole pumping system constructed in accordance with a presently preferred embodiment.

FIG. 2 is a partial cross-sectional view of the motor of the pumping system of FIG. 1.

FIG. 3 is a close-up partial cut-away view of a piece of magnet wire from the motor of FIG. 2.

FIG. 4 is a close-up partial cut-away view of a piece of magnet wire from the motor of FIG. 2.

### DETAILED DESCRIPTION OF THE PREFERRED EMBODIMENTS

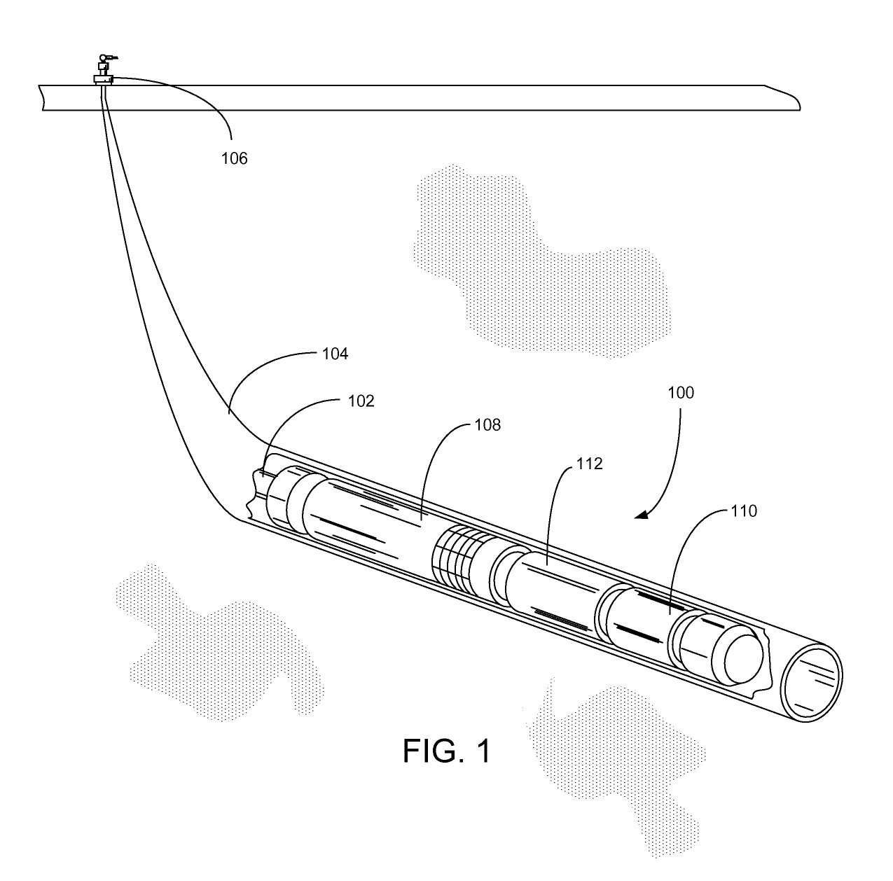

In accordance with a preferred embodiment of the present invention, FIG. 1 shows a front perspective view of a downhole pumping system 100 attached to production tubing 102. The downhole pumping system 100 and production tubing 102 are disposed in a wellbore 104, which is drilled for the production of a fluid such as water or petroleum. The downhole pumping system 100 is shown in a non-vertical well. This type of well is often referred to as a “horizontal” well. Although the downhole pumping system 100 is depicted in a horizontal well, it will be appreciated that the downhole pumping system 100 can also be used in vertical wells.

As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the present invention can also be used to move other fluids. It will also be understood that, although each of the components of the pumping system 100 are primarily disclosed in a submersible application, some or all of these components can also be used in surface pumping operations.

The pumping system 100 preferably includes some combination of a pump assembly 108, a motor assembly 110 and a seal section 112. In a preferred embodiment, the motor assembly 110 is an electrical motor that receives its power from a surface-based supply. The motor assembly 110 converts the electrical energy into mechanical energy, which is transmitted to the pump assembly 108 by one or more shafts. The pump assembly 108 then transfers a portion of this mechanical energy to fluids within the wellbore, causing the wellbore fluids to move through the production tubing to the surface. In a particularly preferred embodiment, the pump assembly 108 is a turbomachine that uses one or more impellers and diffusers to convert mechanical energy into pressure head. In an alternative embodiment, the pump assembly 108 is a progressive cavity (PC) or positive displacement pump that moves wellbore fluids with one or more screws or pistons.

The seal section 112 shields the motor assembly 110 from mechanical thrust produced by the pump assembly 108. The seal section 112 is also preferably configured to prevent the introduction of contaminants from the wellbore 104 into the motor assembly 110. Although only one pump assembly 108, seal section 112 and motor assembly 110 are shown, it will be understood that the downhole pumping system 100 could include additional pumps assemblies 108, seals sections 112 or motor assemblies 110.

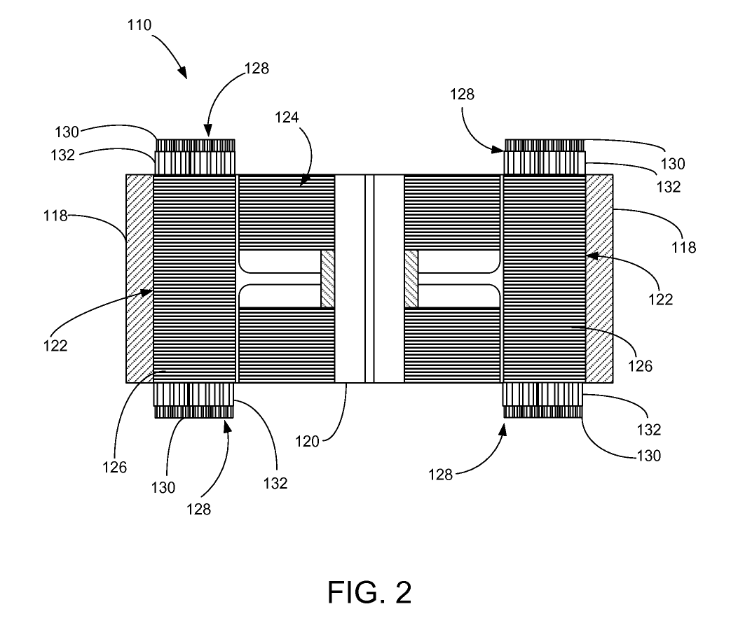

Referring now to FIG. 2, shown therein is an elevational partial cross-section view of the motor assembly 110. The motor assembly 110 includes a motor housing 118, a shaft 120, a stator assembly 122, and a rotor 124. The motor housing 118 encompasses and protects the internal portions of the motor assembly 110 and is preferably sealed to reduce the entry of wellbore fluids into the motor assembly 110. Adjacent the interior surface of the motor housing 118 is the stationary stator assembly 122 that remains fixed relative the motor housing 118. The stator assembly 122 surrounds the interior rotor 124, and includes stator coils (not shown) and a stator core 126. The stator core 126 is formed by stacking and pressing a number of thin laminates to create an effectively solid stator core 126.

The stator core 126 includes multiple stator slots. Each stator coil is preferably created by winding a magnet wire 128 back and forth though slots in the stator core 126. Each time the magnet wire 128 is turned 180° to be threaded back through an opposing slot, an end turn (not shown in FIG. 2) is produced, which extends beyond the length of the stator core 126. The magnet wire 128 includes a conductor 130 and an insulator 132. It will be noted that FIG. 2 provides an illustration of multiple passes of the magnetic wires 128. The coils of magnet wire 128 are terminated and connected to a power source using one of several wiring configurations known in the art, such as a wye or delta configurations.

Electricity flowing through the stator 122 according to different commutation states creates a rotating magnetic field, which acts upon rotor bars (not shown) and causes the rotor 124 to rotate. This, in turn, rotates the shaft 120. The phases in a motor assembly 110 are created by sequentially energizing adjacent stator coils, thus creating the rotating magnetic field. Motors can be designed to have different numbers of phases and different numbers of poles. In a preferred embodiment, an ESP motor is a two pole, three phase motor in which each phase is offset by 120°. It will be understood, however, that the method of the preferred embodiment will find utility in motors with different structural and functional configurations or characteristics.

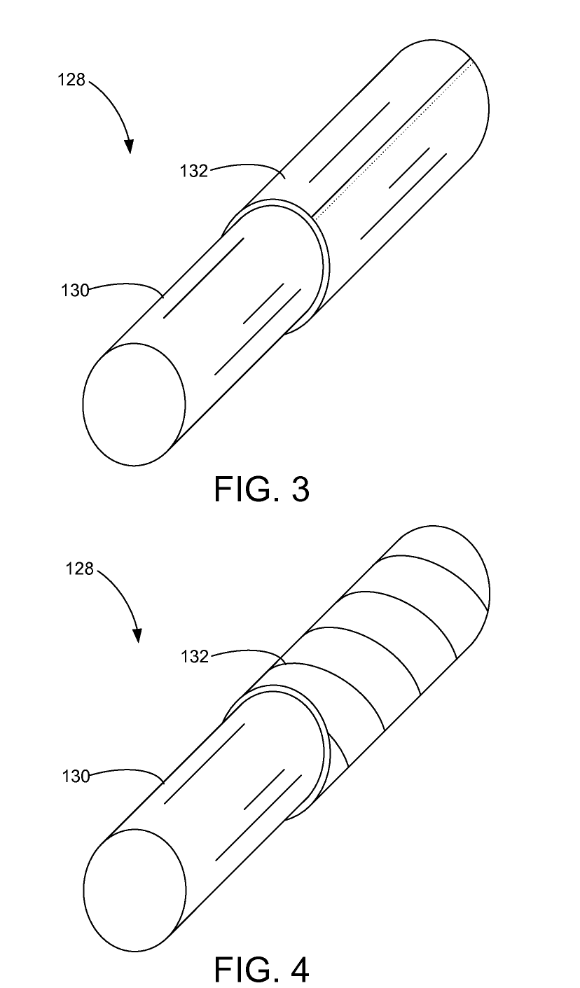

Turning to FIG. 3, shown therein is a perspective view of a short section of the magnetic wire 128. The conductor 130 is preferably constructed from fully annealed, electrolytically refined copper. In an alternative embodiment, the conductor 130 is manufactured from aluminum. Although solid-core conductors 130 are presently preferred, the present invention also contemplates the use of braided or twisted conductors 130. It will be noted that the ratio of the size of the conductor 130 to the insulator 132 is for illustrative purposes only and the thickness of the insulator 132 relative to the diameter of the conductor 130 can be varied depending on the particular application.

In a first preferred embodiment, the insulator 132 is a high quality polyether ether ketone (PEEK) film. Suitable PEEK film is available from Victrex Manufacturing Limited, Rotherham, South Yorkshire, United Kingdom, under the APTIV brand of products. The selected insulator 132 is preferably melt processable, has a relative thermal index (RTI) rating (as established by UL 746B) of about 220° C. and provides excellent chemical and radiation resistance. Furthermore, the selected insulator should also exhibit very good mechanical properties at about 220° C.

Turning to FIGS. 3 and 4, the selected insulator 132 is wrapped around the conductor 130. In FIG. 3, the insulator 132 is wrapped in a manner in which the ends of the film overlap along an axis substantially parallel with the longitudinal axis of the conductor 130. In FIG. 4, the insulator 132 is wrapped in a spiral manner around the conductor 130. In particularly preferred embodiments, two or more layers of the insulator 132 film are wrapped around the conductor 130. It will be appreciated to those of skill in the art that alternative methods of wrapping the insulator 132 around the conductor 130 are within the scope of the present invention.

In both cases, the use of a melt-processable film insulator 132 permits the omission of an adhesive between the insulator 132 and conductor 130. In presently preferred embodiments, the insulator 132 is directly applied to the conductor 130 and then sealed through application of heat to the insulator 132. In a particularly preferred embodiment, the insulator 132 is wrapped around the conductor 130 and then heated to the polymer melting point. Pressure is then applied to bring the molten polymer insulator 132 into full contact with the conductor 130. Heat and pressure can be applied through the combined use of heated anvils or rollers, ultrasonic equipment or lasers. A presently preferred sealing process includes heating the insulator film 132 to about 340-350° C., applying about 4 bar pressure to the molten insulator 132 for between 2-10 seconds, and cool while under pressure to below the glass transition temperature of the polymer.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. An electric motor assembly configured for use in a downhole pumping system, wherein the motor assembly comprises a plurality of stator coils, and wherein one or more of the plurality of stator coils comprises magnet wire having an insulator surrounding a conductor, wherein the insulator is manufactured from a polyether ether ketone film.

2. The electric motor assembly of claim 1, wherein the polyether ether ketone film is applied directly to the conductor without the use of an intervening adhesive.

3. The electric motor assembly of claim 2, wherein the polyether ether ketone film is wrapped around the conductor.

4. The electric motor assembly of claim 3, wherein the polyether ether ketone film is heat sealed around the conductor.

5. The electric motor assembly of claim 1, wherein the polyether ether ketone film has a melting temperature of above about 300° C.

6. The electric motor assembly of claim 1, wherein the polyether ether ketone film has a relative thermal index rating of about 220° C.

7. An electrical submersible pumping system configured for operation in high-temperature applications, the electrical submersible pumping system comprising:
a pump assembly;
a motor assembly connected to pump assembly, wherein the motor assembly comprises a plurality of stator coils, and wherein one or more of the plurality of stator coils comprises magnet wire having an insulator surrounding a conductor, wherein the insulator is manufactured from a polyether ether ketone film.

8. The electrical submersible pumping system of claim 7, wherein the polyether ether ketone film is applied directly to the conductor without the use of an intervening adhesive.

9. The electrical submersible pumping system of claim 8, wherein the polyether ether ketone film is wrapped around the conductor.

10. The electrical submersible pumping system of claim 9, wherein the polyether ether ketone film is heat sealed around the conductor.

11. The electrical submersible pumping system of claim 7, wherein the polyether ether ketone film has a melting temperature above about 300° C.

12. The electrical submersible pumping system of claim 7, wherein the polyether ether ketone film has a relative thermal index rating of about 220° C.

13. A method of manufacturing a motor assembly for use in an electrical submersible pumping system, wherein the motor assembly includes a stator and a rotor, the method of manufacturing comprising the steps of:
providing an insulator film comprised of a polyether ether ketone polymer;
wrapping the insulator film around an electrical conductor to form magnet wire; and
heating the magnet wire to the melting point of the insulator film.

14. The method of claim 13, further comprising the step of placing the magnet wire through the stator to produce motor windings.

15. The method of claim 13, further comprising the step of applying pressure to the magnet wire while the insulator film cools to below the glass transition temperature following the step of heating the magnet wire to the melting point of the insulator film.

16. The method of claim 13, wherein the step of heating the magnet wire further comprises heating the magnet wire to about 340-350° C.

17. The method of claim 16, wherein the method further comprises a step of applying pressure to the magnet wire following the step of heating the magnet wire, wherein the step of applying pressure comprises applying about 4 bar of pressure to the magnet wire.

18. The method of claim 17, wherein the polyether ether ketone polymer has a glass transition temperature and wherein step of applying pressure to the magnet wire further comprises holding the pressure on the magnet wire until the magnet wire cools to a temperature below the glass transition temperature of the polyether ether ketone polymer.
